(19) United States
(12) Patent Application Publication
(10) Pub. No.: US 2007/0091904 A1
(43) Pub. Date: Apr. 26, 2007

(54) Maintaining session information by using a session data structure

(75) Inventors: Marcio Guidorizzi de Siqueira, San Jose, CA (US); Carlos V. Laux, San Ramon, CA (US); Hisham S. Abdelhamid, San Jose, CA (US); Jennifer K. Walker, Jackson, WY (US); Kamakdip S. Toor, San Diego, CA (US)

Correspondence Address: BAKER BOTTS L.L.P., 2001 ROSS AVENUE, SUITE 600, DALLAS, TX, 75201-2980, US

(73) Assignee: Cisco Technology, Inc.

(21) Appl. No.: 11/258,855

(22) Filed: Oct. 25, 2005

(51) Int. Cl. H04L 12/56

(52) U.S. Cl. 370/401; 370/252

(57) ABSTRACT

Maintaining session information includes initiating an access point session between a node and an access point of a local area network. A data structure is received from the access point. The data structure is operable to store session parameter values describing the first access point session, and is maintained the data structure at the node. The access point session is terminated. A next access point session between the node and the access point is initiated. The data structure is sent to the access point, and the access point is operable to use one or more of the session parameter values to establish the next access point session.

### TECHNICAL FIELD

This invention relates generally to the field of telecommunications and more specifically to maintaining session information by using a session data structure.

### BACKGROUND

Nodes such as handsets may communicate with a wireless network through access points. Known techniques manage certain aspects of the communication between nodes and access points. As an example, the access point may be changed as the node moves through the network. Known techniques for managing the communication between nodes and access points, however, may not be satisfactory in certain situations.

### SUMMARY OF THE DISCLOSURE

In accordance with the present invention, disadvantages and problems associated with previous techniques for managing a handoff process may be reduced or eliminated.

According to one embodiment of the present invention, maintaining session information includes initiating an access point session between a node and an access point of a local area network. A data structure is received from the access point. The data structure is operable to store session parameter values describing the first access point session, and is maintained the data structure at the node. The access point session is terminated. A next access point session between the node and the access point is initiated. The data structure is sent to the access point, and the access point is operable to use one or more of the session parameter values to establish the next access point session.

Certain embodiments of the invention may provide one or more technical advantages. A technical advantage of one embodiment may be that a session data structure stored at a node records information about an access point session between the node and an access point. The session data structure may be used to establish a next access point session between the node and the access point. Another technical advantage of one embodiment may be that either the node or the access point may update or modify the information in the session data structure.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 is a block diagram illustrating a system operable to maintain session information by using a session data structure;

FIG. 2 is a block diagram illustrating one embodiment of a node comprising a session data structure; and

FIG. 3 is a call flow diagram illustrating one embodiment of a method for maintaining session information.

### DETAILED DESCRIPTION OF THE DRAWINGS

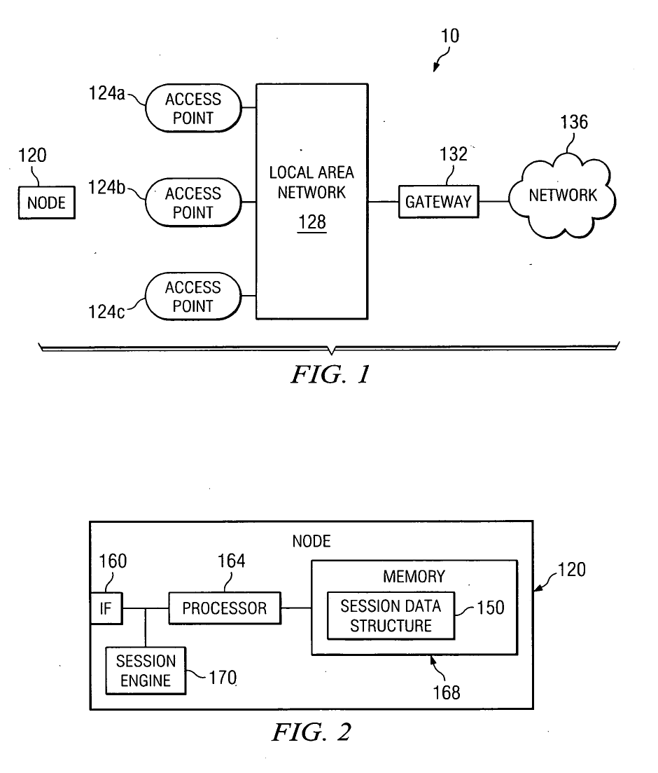

Embodiments of the present invention and its advantages are best understood by referring to FIGS. 1 through 3 of the drawings, like numerals being used for like and corresponding parts of the various drawings.

FIG. 1 is a block diagram illustrating a system 100 operable to maintain session information by using a session data structure. According to the embodiment, a first access point 124a may place a session data structure on a node 120. The session data structure may record information about the communication between node 120 and first access point 124a. Node 120 may be handed off to a second access point 124c and then return to first access point 124a. The session data structure may serve as a record of the previous session, and may be used to efficiently associate node 120 and first access point 124a to establish the next session between node 120 and first access point 124a.

System 100 operates to provide services such as communication sessions to an endpoint such as node 120. A communication session may refer to an active communication between endpoints, measured from endpoint to endpoint. Information is communicated during a communication session. Information may refer to voice, data, text, audio, video, multimedia, control, signaling, other information, or any combination of the preceding. The information may be communicated in packets. A packet may comprise a bundle of data organized in a specific way for transmission, and a frame may comprise the payload of one or more packets organized in a specific way for transmission. A packet-based communication protocol such as Internet Protocol (IP) may be used to communicate the packets.

System 100 may utilize communication protocols and technologies to provide the communication sessions. Example communication protocols and technologies include those set by the Institute of Electrical and Electronics Engineers, Inc. (IEEE) standards, International Telecommunications Union (ITU-T) standards, European Telecommunications Standards Institute (ETSI) standards, Internet Engineering Task Force (IETF) standards, or other standards. As an example, system 100 may operate according to the IEEE 802.xx standards such as the 802.11, 802.15, 802.16, or 802.20 standards. As another example, system 100 may operate according to HiperLAN, cellular, or wired technologies.

According to the illustrated embodiment, system 100 includes node 120 and a set of access points 124a-c coupled as shown. Node 120 represents any suitable communication device operable to communicate with local area network 128 through an access point 124a-c. In general, a device may include any suitable arrangement of components operable to perform the operations of the device, and may comprise logic. “Logic” may refer to hardware, software, other logic, or any suitable combination of the preceding.

Node 120 may comprise, for example, a personal digital assistant, a computer such as a laptop, a cellular telephone, a mobile handset, or any other device operable to communicate with local area network 128 through an access point 124a-c. A node 120 may have a node identifier that uniquely identifies node 120. As an example, a node identifier of a node 120 may comprise the media access control (MAC) address of the node 120. Node 120 is described in more detail with reference to FIG. 2.

Access point 124a-c provides wireless services to a node 120 present in the coverage area of access point 124a-c. An access point may refer to a network point that couples a wireless device, such as node 120, to a wired network, such as local area network 128. Access point 124a-c may comprise any suitable logic operable to provide wireless services. According to one embodiment, access point 124a-c includes a receiver or transmitter or both a receiver and a transmitter. As an example, access point 124a-c may include an omni-directional antenna operable to communicate with one or more nodes 120. Access point 124a-c may have an access point identifier that uniquely identifies access point 124a-c. As an example, an access point identifier of an access point 124a-c may comprise the media access control (MAC) address of the access point 124a-c.

In general, nodes communicate with access points over channels using any suitable protocol. A channel may refer to a communication link with a specific frequency band. According to one embodiment, nodes may communicate with access points using protocols defined in the IEEE 802.11 standards, such as the 802.11b, 802.11g, and 802.11a standards.

The 802.11b and 802.11g standards operate in the unlicensed 2.4 gigahertz (GHz) band. The 802.11b and 802.11g standards divide the band into 14 overlapping, staggered channels with center frequencies that are 5 megahertz (MHz) apart. The 802.11b and 802.11g standards specify the center frequency of each channel and a spectral mask for each channel. The spectral mask for 802.11b may require that the signal be at least 30 dB down from its peak energy at ±11 MHz from the center frequency and at least 50 decibels (dB) down from its peak energy at ±22 MHz from the center frequency.

The 802.11a standard operates in the 5 GHz band. The band is divided into 12 non-overlapping channels. Eight of the channels are dedicated to indoor use, and four of the channels are dedicated to point-to-point use. The 802.11a standard uses an orthogonal frequency-division multiplexing (OFDM) process with 52 subcarriers. Forty-eight subcarriers are data subcarriers, and 4 subcarriers are pilot subcarriers with a carrier separation of 0.3125 MHz (20 MHz/64). The total bandwidth is 20 MHz with an occupied bandwidth of 16.6 MHz.

As an example, node 120 may be designed to operate in the following three Unlicensed National Information Infrastructure (UNNI)channel bands:

Lower: 36, 40, 44, 48 at 40 milliwatts;

Middle: 52, 56, 60, 64 at 200 milliwatts; and

Upper: 149, 153, 157, 161 at 800 milliwatts.

The upper channel band may be reserved for outdoor applications, and the middle and lower channel bands may be reserved for indoor use.

In general, different access points may communicate over different designated channels, and a node communicates with an access point over its designated channel. As a node moves through a network, a handover process may be performed between access points. As a node moves from the coverage area of a first access point to the coverage area of a second access point, the first access point hands over the communication session to the second access point.

An access point session may refer to the portion of a communication session during which node 120 communicates with a particular access point 124a. As an example, node 120 may engage in a first access point session with a first access point 124a, and then engage in a second access point session with a second access point 124b. Typically, node 120 and access point 124b perform a set of processes, such as a login process, to establish a new access point session.

According to one embodiment, a first access point 124a may place a session data structure on a node 120. The session data structure may record information about the access point session between node 120 and first access point 124a. Node 120 may be handed off to a second access point 124b and then return to first access point 124a. The session data structure may be used to efficiently associate node 120 and first access point 124a to establish communication between node 120 and first access point 124a.

According to the illustrated embodiment, system 100 also includes a local area network 128, a gateway 132, and a wide area network 136 coupled as shown. Local area network 128 represents a communications network that couples communication devices within a limited region such as a building or campus. Typically, devices of a local area network may communicate with each other by transmitting information directly to each other without transmitting the information outside of the network.

Gateway 132 represents any suitable device operable to interconnect with network 128. Gateway 132 may convert communications between different communication protocols. For example, gateway 132 may convert communications from a protocol used by network 128 to a different protocol, or vice-versa.

Network 136 represents a communication network that allows devices such as node 120 to communicate with other devices. A communication network may comprise all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, other suitable communication link, or any combination of the preceding.

One or more components of system 100 may operate on one or more computers and may include appropriate input devices, output devices, mass storage media, processors, memory, or other components for receiving, processing, storing, and communicating information according to the operation of system 100. As used in this document, the term “computer” refers to any suitable device operable to accept input, process the input according to predefined rules, and produce output, for example, a personal computer, work station, network computer, wireless telephone, handset, personal digital assistant, one or more microprocessors within these or other devices, or any other suitable processing device.

As an example, one or more components of system 100 may include logic, an interface, memory, other component, or any suitable combination of the preceding. Certain logic may manage the operation of a device, and may comprise, for example, a processor. “Processor” may refer to any suitable device operable to execute instructions and manipulate data to perform operations. “Interface” may refer to logic of a device operable to receive input for the device, send output from the device, perform suitable processing of the input or output or both, or any combination of the preceding, and may comprise one or more ports, conversion software, or both. “Memory” may refer to logic operable to store and facilitate retrieval of information, and may comprise Random Access Memory (RAM), Read Only Memory (ROM), a magnetic drive, a disk drive, a Compact Disk (CD) drive, a Digital Video Disk (DVD) drive, removable media storage, any other suitable data storage medium, or a combination of any of the preceding.

Modifications, additions, or omissions may be made to system 100 without departing from the scope of the invention. The components of system 100 may be integrated or separated according to particular needs. Moreover, the operations of system 100 may be performed by more, fewer, or other modules. For example, the operations of scanning engine 140 and handoff initiator 144 may be performed by one module, or the operations of scanning engine 140 may be performed by more than one module. Additionally, operations of system 100 may be performed using any suitable logic. As used in this document, “each” refers to each member of a set or each member of a subset of a set.

FIG. 2 is a block diagram illustrating one embodiment of a node 120 comprising a session data structure 150. According to the embodiment, node 120 includes an interface 160, a processor 164, a memory 168, and a session engine 170 coupled as shown. Interface 160, processor 164, and memory 168 may be as described with reference to FIG. 1.

According to the embodiment, memory 168 stores session data structure 150. Session data structure 150 may represent a data structure that includes cached information that serves as a record of an access point session, and may be used to efficiently establish a next access point session. As an example, data structure 150 may comprise a “cookie.” Data structure 150 may include any suitable components. As an example, data structure 150 may include a component added by an access point 124a, a component added by a node 120, other suitable component, or any combination of the preceding.

Node 120 includes a data structure 150 for each access point 124a-c with which node 120 had an access point session. Data structure 150 may allow an access point 124a to store and retrieve information from node 120, and may be persistent, that is, remain in memory 168 for subsequent use. According to one embodiment, data structure 150 may be retrieved by access point 124a when node 120 attempts to re-associate with access point 124a. According to another embodiment, data structure 150 may be retrieved by other access points 124b-c when node 120 attempts to establish communication with the access points 124b-c.

Session data structure 150 may comprise any suitable data structure, for example, a text file. Data structure 150 for an access point 124a may be indexed by the access point identifier of the access point 124a. The information of data structure 150 may be presented in any suitable manner. As an example, the information may be presented as session parameter values of session parameters describing an access point session.

Examples of information recorded by data structure 150 include channel data, session data, technique data, other information describing a access point session, or any combination of the preceding. Channel data describes the 802.11 channel that node 120 used during the access point session to connect to access point 124a. Channel data may include, for example, the channel identifier of the channel. Channel data may also include characteristics of the physical channel, for example, the signal level, noise level, path loss factors, in-band interference level, or other characteristic.

Session data includes data describing the access point session. Session data may include the last usable data rate of the access point session, power level of the access point session, or duration of the session. Session data may also include the traffic rate requested by node 120 and the traffic rate that was actually used. Technique data includes the techniques used for processing traffic during the access point session. As an example, technique data may include the authentication technique, encryption technique, or other technique used to process the packets during the access point session.

According to the illustrated embodiment, node 120 includes a session engine 170. Session engine 170 manages access point sessions with access points 124a-c. According to one embodiment, session engine 170 establishes access point sessions with access points 124a-c and maintains data structure 150. An access point session may be established by performing standard initiation processes, such as a login process. During these processes, session engine 170 may send data structure 150 to access point 124a.

Access point 124a may use data structure 150 for any suitable purpose. As an example, data structure 150 may be used to install the initial state of an access point session. As another example, data structure 150 may be used to automatically identify node 120 to access point 124a, which may reduce or eliminate the user identification portion of the login process. As another example, data structure 150 describing the history of the previous access point session may be used to troubleshoot a current session. As yet another example, data structure 150 may store information such as number of packets that were not successfully transmitted by node 120 or number of retransmission attempts or both, which may be used to troubleshoot network problems.

Data structure 150 may be maintained by updating or otherwise modifying the session parameter values of data structure 150. During the communication between access point 124a and node 120, either access point 124a or session engine 170 may add information to or update information of data structure 150. According to one embodiment, access point 124a may instruct node 120 to collect data and update data structure 150. Data structure 150 may be updated at any suitable time. As an example, data structure 150 may be periodically updated during the access point session or after the access point session has terminated.

As an example, node 120 may update data structure 150 with statistics about a session with an access point 124a. For example, node 120 may periodically update data structure 150 with information such as the average packet loss and the average number of re-transmissions over a determined amount of time. The information could be displayed by access point 124a or node 120 as a mechanism to evaluate network quality.

The fields of data structure 150 may be processed in any suitable manner by session engine 170 or access point 124a. As an example, the fields may be encrypted, digitally signed, compressed, subject to other process, or any combination of the preceding. According to one embodiment, access point 124a may encrypt fields to which it contributed information, session engine 170 may encrypt fields to which it contributed information, and both session engine 170 and access point 124a may sign the data structure 150. Public key cryptography may be used to encrypt and sign data structure 150.

Session engine 170 may perform other suitable operations to maintain access point sessions. As an example, session engine 170 may perform scans to determine the channels of access points 124a that can communicate with node 120. According to one embodiment, node 20 may operate in a current channel of a current frequency range, while scanning engine 140 performs scans to discover other channels in the current frequency range or outside of the current frequency range. As another example, session engine 170 may determine the point at which a handoff process is to be initiated.

Modifications, additions, or omissions may be made to node 120 without departing from the scope of the invention. The components of node 120 may be integrated or separated according to particular needs. Moreover, the operations of node 120 may be performed by more, fewer, or other modules. For example, the operations of session engine 170 may be performed by more than one module. Additionally, operations of node 120 may be performed using any suitable logic.

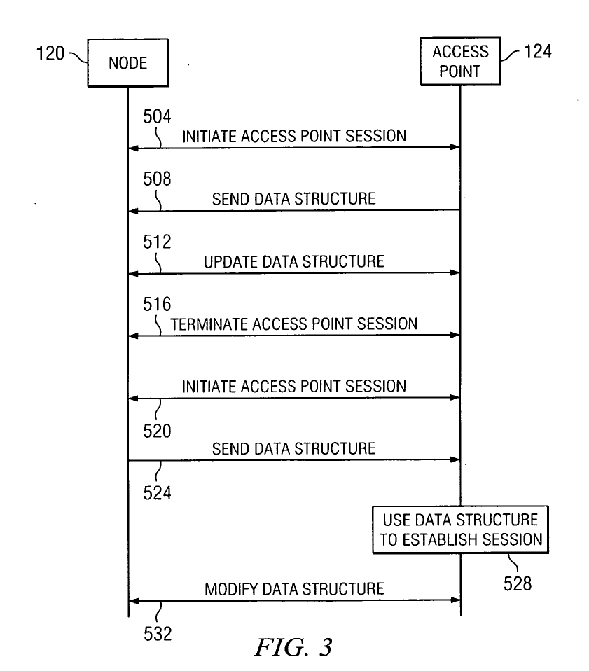

FIG. 3 is a call flow diagram illustrating one embodiment of a method for maintaining session information. According to the embodiment, data structure 150 serves as a record of a session between node 120 and access point 124a. Data structure 150 may include a component added by access point 124a, a component added by node 120, other suitable component, or any combination of the preceding. Data structure 150 may be used to establish the next session between node 120 and access point 124a, or may be used to establish a session between node 120 and another access point 124b-c.

The method begins at step 504, where a first access point session is facilitated between node 120 and access point 124a. The first access point session may be initiated when node 120 enters the coverage area of access point 124a. Access point 124a sends a data structure 150 to node 120 at step 508. Data structure 150 may be used to store session information about the first access point session.

Data structure 150 is updated at step 512. The data structure may be updated by node 120 or access point 124a. The first access point session is terminated at step 516. A second access point session is initiated at step 520. Node 120 sends data structure 150 to access point 124a at step 524. Access point 124a uses data structure 150 to initiate the second access point session.

Certain parameter values may not apply for the second access point section, so node 120 and access point 124a may modify the data structure 150 at step 532. After modifying the data structure, the method ends.

Modifications, additions, or omissions may be made to the method without departing from the scope of the invention. The method may include more, fewer, or other steps. Additionally, steps may be performed in any suitable order without departing from the scope of the invention.

Certain embodiments of the invention may provide one or more technical advantages. A technical advantage of one embodiment may be that a session data structure stored at a node records information about an access point session between the node and an access point. The session data structure may be used to establish a next access point session between the node and the access point. Another technical advantage of one embodiment may be that either the node or the access point may update or modify the information in the session data structure.

While this disclosure has been described in terms of certain embodiments and generally associated methods, alterations and permutations of the embodiments and methods will be apparent to those skilled in the art. Accordingly, the above description of example embodiments does not constrain this disclosure. Other changes, substitutions, and alterations are also possible without departing from the spirit and scope of this disclosure, as defined by the following claims.

What is claimed is:

1. A method for maintaining session information, comprising:
initiating a first access point session between a node and an access point of a local area network;
receiving a data structure from the access point, the data structure operable to store a plurality of session parameter values, a session parameter value describing the first access point session;
maintaining the data structure at the node;
terminating the first access point session;
initiating a second access point session between the node and the access point; and
sending the data structure to the access point, the access point operable to use one or more of the plurality of session parameter values to establish the second access point session.

2. The method of claim 1, wherein maintaining the data structure at the node further comprises:
establishing at the node that a session parameter value is to be updated; and
updating the session parameter value.

3. The method of claim 1, wherein maintaining the data structure at the node further comprises:
receiving an updated session parameter value from the access point; and
updating a session parameter value according to the updated session parameter value.

4. The method of claim 1, wherein maintaining the data structure at the node further comprises:
updating a session parameter value; and
encrypting the updated session parameter value.

5. The method of claim 1, further comprising:
receiving a request from the access point to modify a session parameter value; and
modifying the session parameter value in response to the request.

6. The method of claim 1, wherein the node and the access point are operable to communicate according to an Institute of Electrical and Electronics Engineers, Inc. (IEEE) 802.11 protocol.

7. A node apparatus for maintaining session information, comprising:
an interface operable to communicate with an access point of a local area network; and
a processor coupled to the interface and operable to:
facilitate a first access point session with the access point;
receive a data structure from the access point, the data structure operable to store a plurality of session parameter values, a session parameter value describing the first access point session;
maintain the data structure at the node;
terminate the first access point session;
facilitate a second access point session with the access point; and
send the data structure to the access point, the access point operable to use one or more of the plurality of session parameter values to establish the second access point session.

8. The node apparatus of claim 7, the processor further operable to maintain the data structure at the node by:
establishing at the node that a session parameter value is to be updated; and
updating the session parameter value.

9. The node apparatus of claim 7, the processor further operable to maintain the data structure at the node by:
receiving an updated session parameter value from the access point; and
updating a session parameter value according to the updated session parameter value.

10. The node apparatus of claim 7, the processor further operable to maintain the data structure at the node by:
updating a session parameter value; and
encrypting the updated session parameter value.

11. The node apparatus of claim 7, the processor further operable to:
receive a request from the access point to modify a session parameter value; and
modify the session parameter value in response to the request.

12. The node apparatus of claim 7, wherein the processor and the access point are operable to communicate according to an Institute of Electrical and Electronics Engineers, Inc. (IEEE) 802.11 protocol.

13. The node apparatus of claim 7, wherein:
the processor is further operable to maintain the data structure at the node by:
establishing at the node that a first session parameter value is to be updated;
updating the first session parameter value;
receiving an updated session parameter value from the access point;
updating a second session parameter value according to the updated session parameter value;
updating a third session parameter value; and
encrypting the updated third session parameter value;
receive a request from the access point to modify a fourth session parameter value; and
modify the fourth session parameter value in response to the request; and
the processor and the access point are operable to communicate according to an Institute of Electrical and Electronics Engineers, Inc. (IEEE) 802.11 protocol.

14. A system for maintaining session information, comprising:
means for initiating a first access point session between a node and an access point of a local area network;
means for receiving a data structure from the access point, the data structure operable to store a plurality of session parameter values, a session parameter value describing the first access point session;
means for maintaining the data structure at the node;
means for terminating the first access point session;
means for initiating a second access point session between the node and the access point; and
means for sending the data structure to the access point, the access point operable to use one or more of the plurality of session parameter values to establish the second access point session.

15. A system for maintaining session information, comprising:
an access point of a local area network, the access point operable to generate a data structure; and
a node in communication with the access point and operable to:
facilitate a first access point session with the access point;
receive the data structure from the access point, the data structure operable to store a plurality of session parameter values, a session parameter value describing the first access point session;
maintain the data structure;
terminate the first access point session;
facilitate a second access point session with the access point; and
send the data structure to the access point;
the access point further operable to use one or more of the plurality of session parameter values to establish the second access point session.

16. The system of claim 15, the node further operable to maintain the data structure by:
establishing at the node that a session parameter value is to be updated; and
updating the session parameter value.

17. The system of claim 15, the node further operable to maintain the data structure by:
receiving an updated session parameter value from the access point; and
updating a session parameter value according to the updated session parameter value.

18. The system of claim 15, the node further operable to maintain the data structure by:
updating a session parameter value; and
encrypting the updated session parameter value.

19. The system of claim 15, the node further operable to:
receive a request from the access point to modify a session parameter value; and
modify the session parameter value in response to the request.

20. The system of claim 15, wherein the node and the access point are operable to communicate according to an Institute of Electrical and Electronics Engineers, Inc. (IEEE) 802.11 protocol.

21. The system of claim 15, wherein:
the node is further operable to maintain the data structure at the node by:
establishing that a first session parameter value is to be updated;
updating the first session parameter value;
receiving an updated session parameter value from the access point;
updating a second session parameter value according to the updated session parameter value;
updating a third session parameter value; and
encrypting the updated third session parameter value;
receive a request from the access point to modify a fourth session parameter value; and
modify the fourth session parameter value in response to the request; and
the node and the access point are operable to communicate according to an Institute of Electrical and Electronics Engineers, Inc. (IEEE) 802.11 protocol.
